(19) United States
(12) Patent Application Publication
(10) Pub. No.: US 2025/0005614 A1
(43) Pub. Date: Jan. 2, 2025

(54) Incentive Based Cloud Resource Provisioning

(71) Applicant: Dell Products L.P., Round Rock, TX (US)

(72) Inventors: Vinay Sawal, Fremont, CA (US); Viswanath Ponnuru, Bangalore (IN); Ratnesh Yadav, Kirkland, WA (US)

(21) Appl. No.: 18/343,664

(22) Filed: Jun. 28, 2023

(51) Int. Cl. G06Q 30/0207; G06F 1/3296; G06Q 10/0631

(52) U.S. Cl. CPC G06Q 30/0215; G06F 1/3296; G06Q 10/06313

(57) ABSTRACT

A system can identify an unclaimed computing resource of computing resources installed for a user account on premises at a physical location associated with the user account, wherein the system is configured to remotely manage the computing resources. The system can analyze a state of the computing resources to determine a trust factor that is associated with the user account. The system can set a power configuration of the unclaimed computing resource to a lower power consumption state relative to a current power consumption state based on the trust factor and a resource consumption history of the computing resources that is associated with the user account.

### BACKGROUND

Computer systems can be managed remotely.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify an unclaimed computing resource of computing resources installed for a user account on premises at a physical location associated with the user account, wherein the system is configured to remotely manage the computing resources. The system can analyze a state of the computing resources to determine a trust factor that is associated with the user account. The system can set a power configuration of the unclaimed computing resource to a lower power consumption state relative to a current power consumption state based on the trust factor and a resource consumption history of the computing resources that is associated with the user account.

An example method can comprise identifying, by a system comprising a processor, an unclaimed computing resource of computing resources installed on premises at a physical location associated with a user account. The method can further comprise analyzing, by the system, a state of the computing resources to determine a trust value that is associated with the user account. The method can further comprise setting, by the system, a power configuration of the unclaimed computing resource to a reduced power consumption state relative to a current power consumption state based on the trust value and a resource consumption history of the computing resources that is associated with the user account.

An example non-transitory computer-readable medium can comprise instructions that, in response to execution, cause a system comprising a processor to perform operations. These operations can comprise identifying an unclaimed computing resource of computing resources installed on premises at a physical location associated with an account. These operations can further comprise analyzing a state of the computing resources to determine a trust value that is associated with the account. These operations can further comprise setting a power configuration of the unclaimed computing resource from a first power consumption state to a second power consumption state lower than the first power consumption state based on the trust value and a resource consumption history of the computing resources that is associated with the account.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate incentive based cloud resource provisioning, in accordance with an embodiment of this disclosure;

FIG. 2 illustrates another example system architecture that can facilitate incentive based cloud resource provisioning, in accordance with an embodiment of this disclosure;

FIG. 3 illustrates another example system architecture that can facilitate incentive based cloud resource provisioning, in accordance with an embodiment of this disclosure;

FIG. 4 illustrates an example process flow that can facilitate incentive based cloud resource provisioning, in accordance with an embodiment of this disclosure;

FIG. 5 illustrates another example system architecture that can facilitate incentive based cloud resource provisioning, in accordance with an embodiment of this disclosure;

FIG. 6 illustrates another example process flow that can facilitate incentive based cloud resource provisioning, in accordance with an embodiment of this disclosure;

FIG. 7 illustrates another example process flow that can facilitate incentive based cloud resource provisioning, in accordance with an embodiment of this disclosure;

FIG. 8 illustrates another example process flow that can facilitate incentive based cloud resource provisioning, in accordance with an embodiment of this disclosure;

FIG. 9 illustrates another example process flow that can facilitate incentive based cloud resource provisioning, in accordance with an embodiment of this disclosure;

FIG. 10 illustrates another example process flow that can facilitate incentive based cloud resource provisioning, in accordance with an embodiment of this disclosure;

FIG. 11 illustrates another example process flow that can facilitate incentive based cloud resource provisioning, in accordance with an embodiment of this disclosure;

FIG. 12 illustrates another example process flow that can facilitate incentive based cloud resource provisioning, in accordance with an embodiment of this disclosure;

FIG. 13 illustrates another example process flow that can facilitate incentive based cloud resource provisioning, in accordance with an embodiment of this disclosure;

FIG. 14 illustrates an example block diagram of a computer operable to execute an embodiment of this disclosure.

### DETAILED DESCRIPTION

### Overview

In a subscription scenario for computing resources, consumers can end up paying for the resources, even if the resource has not been used, thus resulting in significant over-subscription (or under-utilization). A problem with over-subscription and/or under-utilization where the corresponding computers are remotely managed can be that forgotten and unclaimed resources can present opportunities for hackers to attack a service provider and exploit its network. Another problem with over-subscription and/or under-utilization where the corresponding computers are remotely managed can be that there is needless energy consumption related to managing these computers. Another problem with over-subscription and/or under-utilization where the corresponding computers are remotely managed can be that an unclaimed service does not provide a customer with a cost benefit, where a cost of a subscription is fixed.

An unclaimed resource can generally comprise a computing resource that is acquired as part of a subscription (e.g., a subscription to have computing servers for a period of time), but that has not been claimed by the customer, such as by onboarding and utilizing it. An unclaimed resource can carry with it security risks (e.g., where it is not managed by a cloud services platform to patch security issues) as well as increase an amount of electrical power consumption by virtue of running it.

The present techniques can be implemented to address these problems with over-subscription and/or under-utilization where the corresponding computers are remotely managed.

The present techniques can be implemented to facilitate an incentive-based subscription to reduce energy consumption, to a benefit of both service providers and consumers. The present techniques can be implemented to facilitate a trust classifier can be implemented to analyze a service consumption history data model and cloud resources to be utilized by a trustworthy consumer to classify a consumer's trustworthiness. The present techniques can also be implemented to facilitate a power efficiency data configuration model based on tenant usage statistics to benefit service provider energy consumption.

### Example Architectures

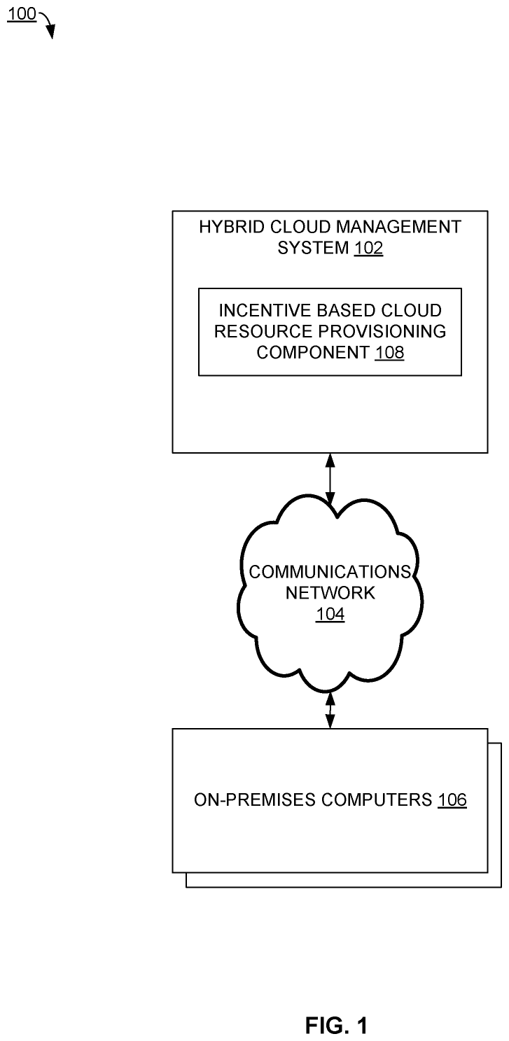

FIG. 1 illustrates an example system architecture 100 that can facilitate incentive based cloud resource provisioning, in accordance with an embodiment of this disclosure.

System architecture 100 comprises hybrid cloud management system 102, communications network 104, and on-premises computers 106. In turn, hybrid cloud management system 102 comprises incentive based cloud resource provisioning component 108.

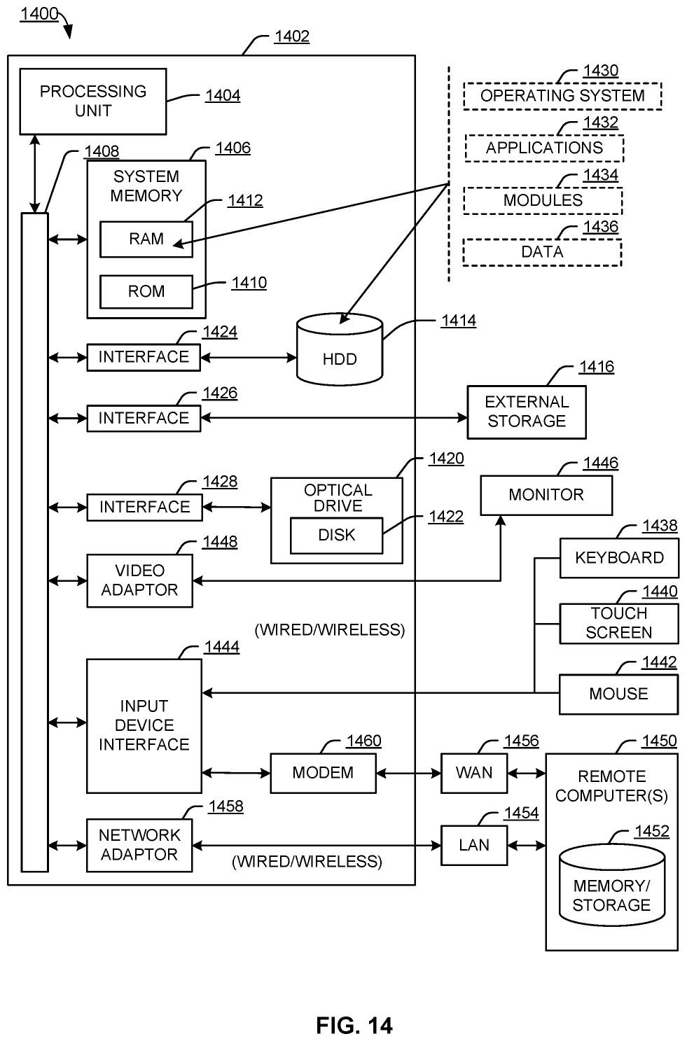

Each of hybrid cloud management system 102 and/or on-premises computers 106 can be implemented with part(s) of computing environment 1400 of FIG. 14. Communications network 104 can comprise a computer communications network, such as the Internet.

On-premises computers 106 can comprise one or more computers that are installed on a customer's premises and are (or are to be) managed by hybrid cloud management system 102. As part of that, hybrid cloud management system 102 can identify unclaimed resources on-premises or hosted by hybrid cloud management system 102, and based on a determined trust confidence factor, offer an incentive to a consumer that has a subscription for on-premises computers 106 to transition one or more computers to a low power mode.

A consumer can generally subscribe to resources provided by, and managed by, hybrid cloud management system 102. In some examples, there is a set cost for this subscription that does not vary based on how much of the subscribed resources the consumer utilizes. In implementing the present techniques, incentive based cloud resource provisioning component 108 can identify resources that can be transitioned to a low power state (or otherwise have an ongoing cost of operating the resources reduced), and provide an incentive to the consumer to do so. In some examples, this incentive can be a reduction in a cost of the subscription.

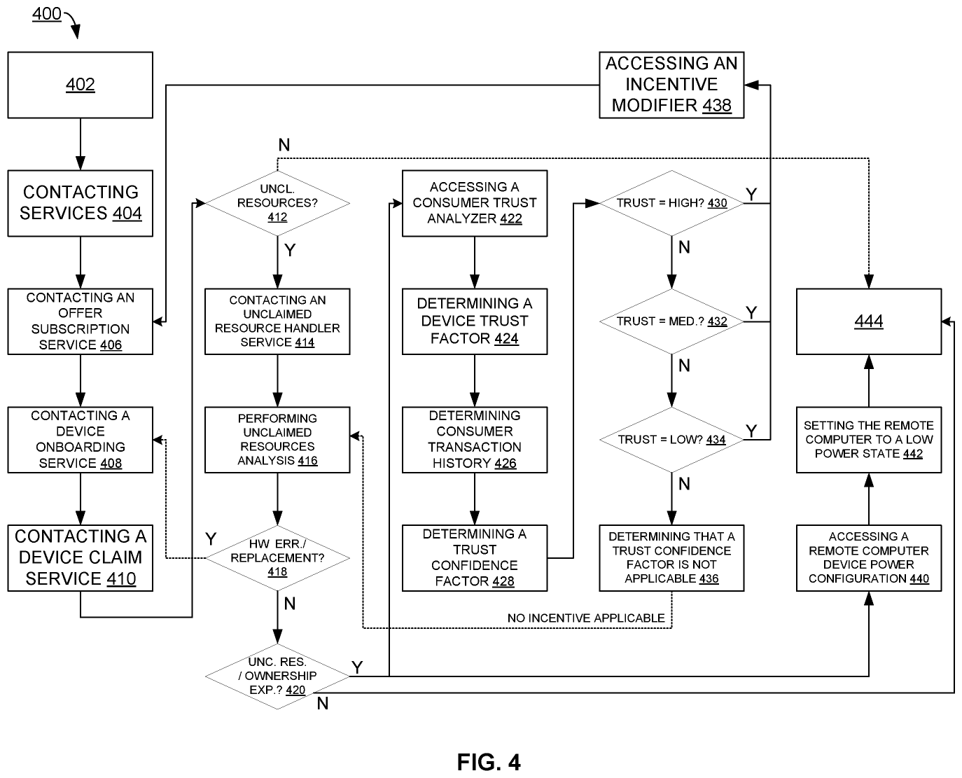

In some examples, incentive based cloud resource provisioning component 108 can implement part(s) of the process flows of FIGS. 4 and/or 6-13 to implement incentive based cloud resource provisioning.

It can be appreciated that system architecture 100 is one example system architecture for incentive based cloud resource provisioning, and that there can be other system architectures that facilitate incentive based cloud resource provisioning.

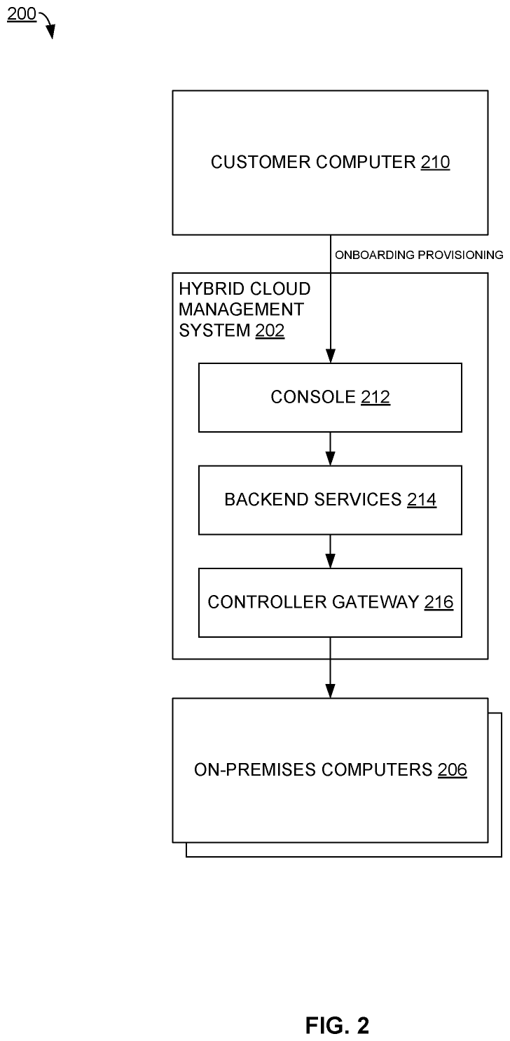

FIG. 2 illustrates another example system architecture 200 that can facilitate incentive based cloud resource provisioning, in accordance with an embodiment of this disclosure. In some examples, part(s) of system architecture 200 can be used to implement part(s) of system architecture 100 of FIG. 1.

System architecture 200 comprises hybrid cloud management system 202 (which can be similar to hybrid cloud management system 102 of FIG. 1), on-premises computers 206 (which can be similar to on-premises computers 106), and customer computer 210. In turn, hybrid cloud management system 202 comprises console 212, backend services 214, and controller gateway.

Customer computer 210 can contact hybrid cloud management system 202 to create a subscription for on-premises computers 206. This message from customer computer 210 can be received at console 212 (which can generally comprise a front end of hybrid cloud management system 202 that is configured to interact with customer computer 210), and can be communicated through backend services 214 and controller gateway 216 to perform onboarding provisioning of one or more computers of on-premises computers 206.

Backend services 214 can comprise a collection of services running in the cloud that are configured to provide backend functions for running services for a customer subscribing to cloud resources. Controller gateway 216 can comprise communication infrastructure that is configured to connect cloud services to a remote endpoint that is physically located on-premises for a customer.

It can be determined that some computers of on-premises computers 206 are unclaimed, and/or at risk of unauthorized access without proper governance. To mitigate this type of risk, incentive based cloud resource provisioning (such as that of incentive based cloud resource provisioning component 108 of FIG. 1) can be implemented.

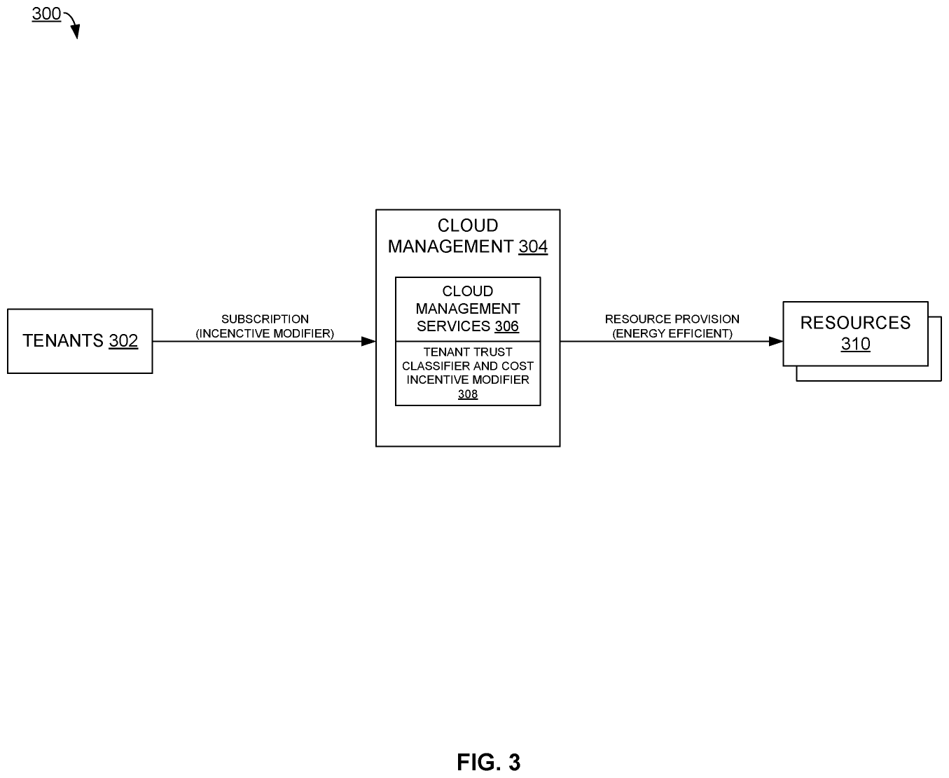

FIG. 3 illustrates another example system architecture that can facilitate incentive based cloud resource provisioning, in accordance with an embodiment of this disclosure. In some examples, part(s) of system architecture 300 can be used to implement part(s) of system architecture 100 of FIG. 1 to facilitate incentive based cloud resource provisioning.

System architecture 300 comprises tenants 302, cloud management 304 (Which comprises cloud management services 306 and tenant trust classifier and cost incentive modifier 308), and resources 310.

Tenants 302 (which can be similar to one or more instances of customer computer 210 of FIG. 2) can subscribe to resources 310 that are offered by cloud management 304. This subscription can be modified by an incentive (such as a reduction in price associated with the subscription) based on a determination by tenant trust classifier and cost incentive modifier 308. Cloud management 304 can manage resources 310 (such as by provisioning and on-boarding computers of resources 310.

Resources 310, which can be similar to on-premises computers 106 of FIG. 1, can comprise on-premises computers and/or cloud service resources (such as hosted computing resources that are available to tenants 302 via a communications network).

As part of provisioning resources 310, cloud management 304 can implement incentive based cloud resource provisioning to reduce energy costs associated with operating resources 310.

### Example Process Flow

FIG. 4 illustrates an example process flow 400 that can facilitate incentive based cloud resource provisioning, in accordance with an embodiment of this disclosure. In some examples, one or more embodiments of process flow 400 can be implemented by incentive based cloud resource provisioning component 108 of FIG. 1, or computing environment 1400 of FIG. 14.

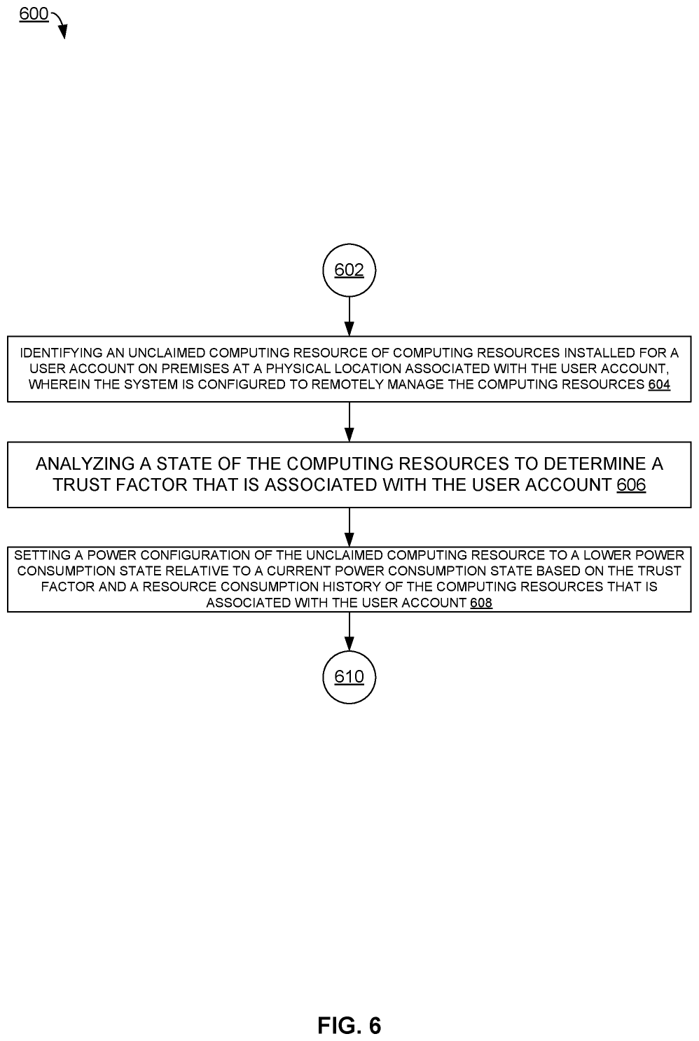

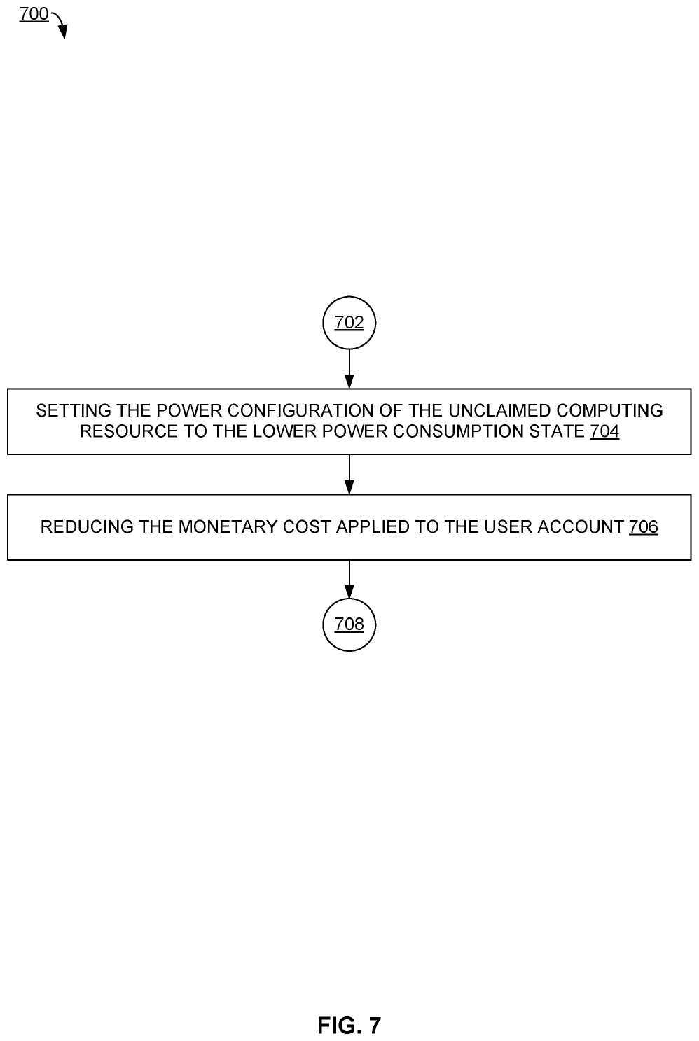

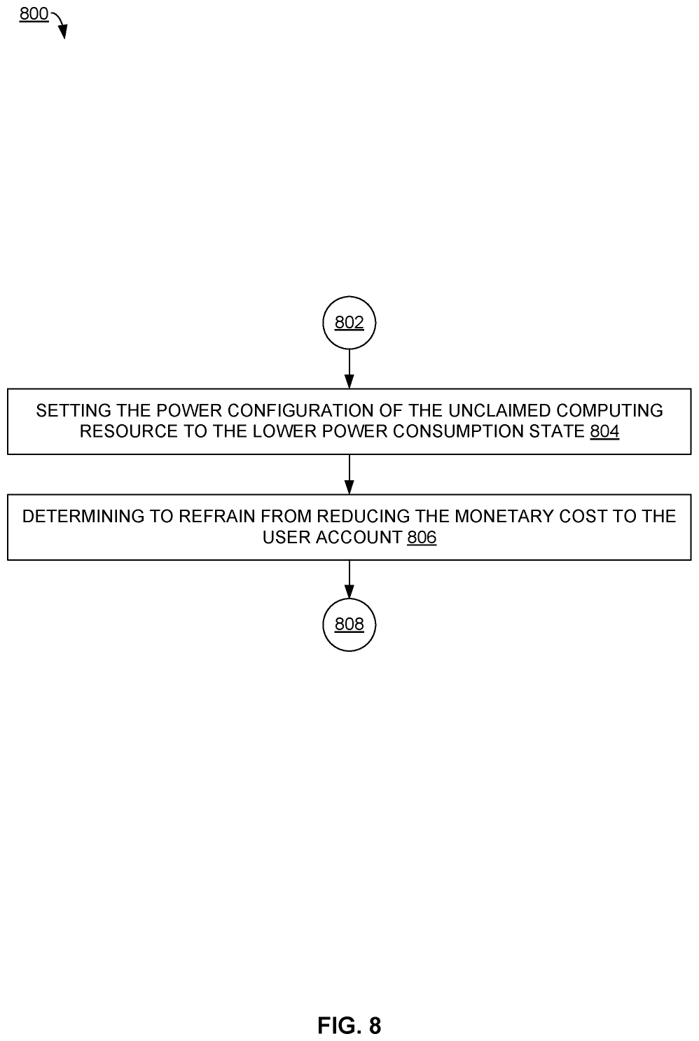

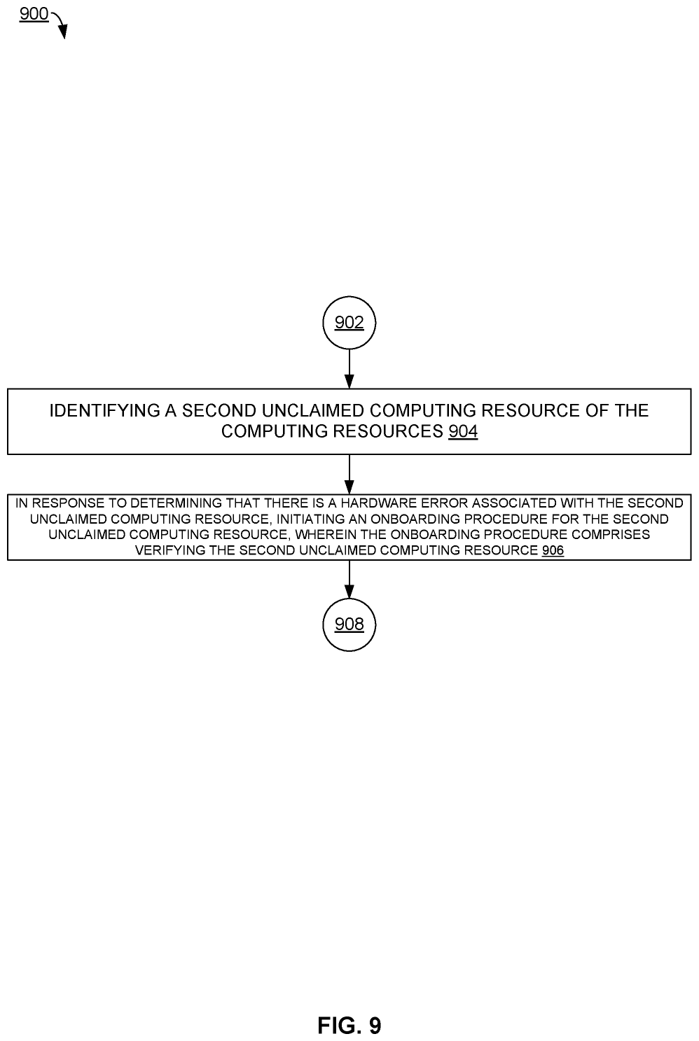

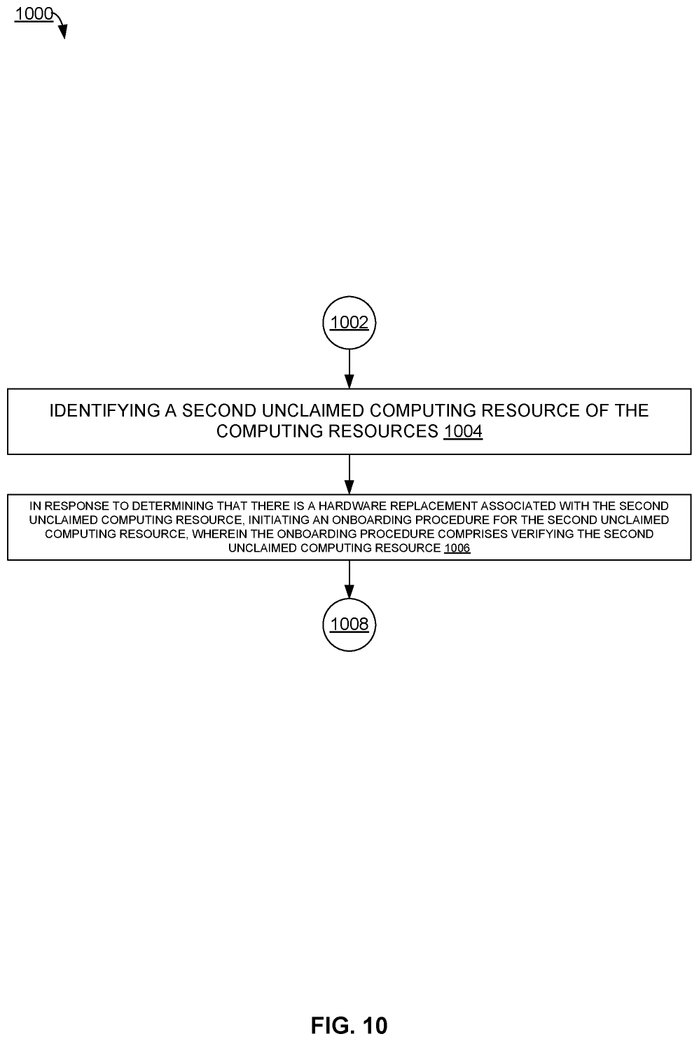

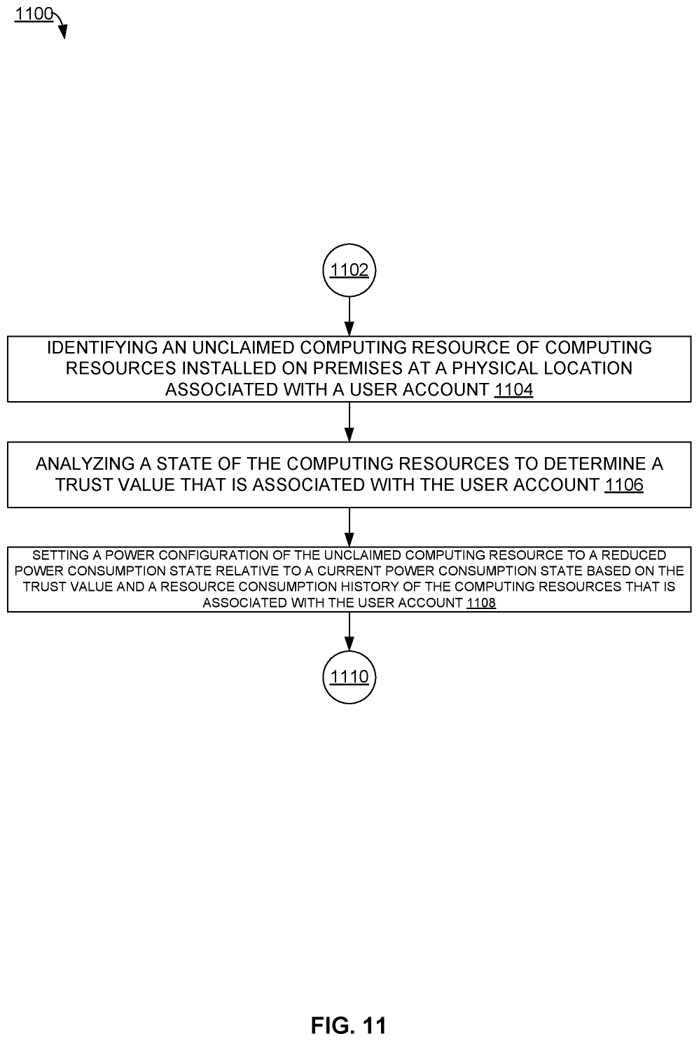

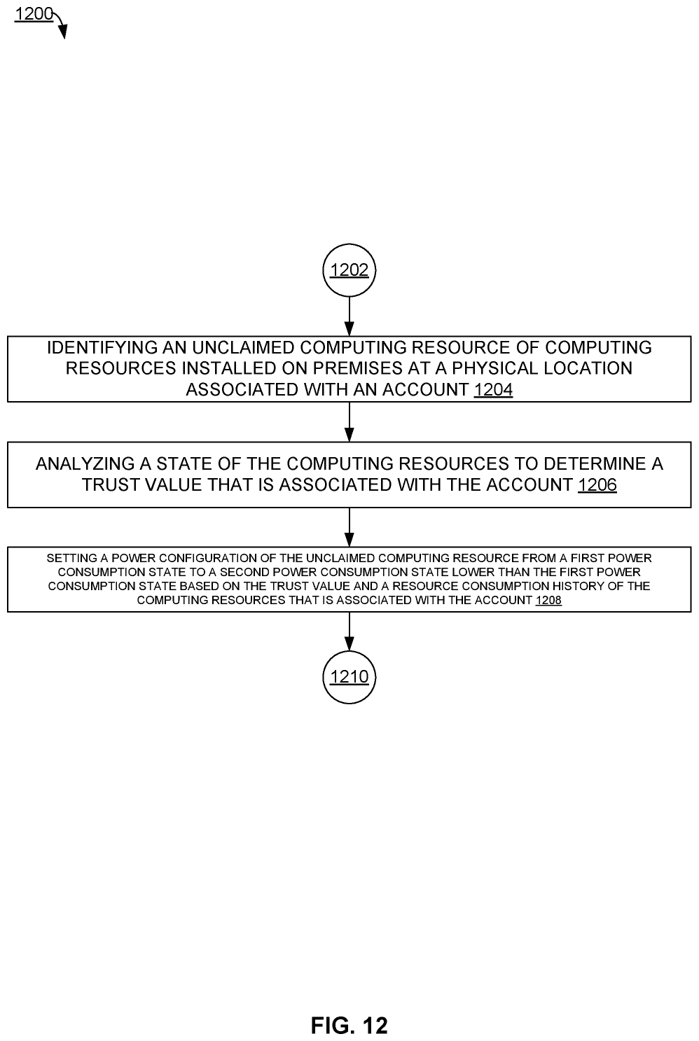

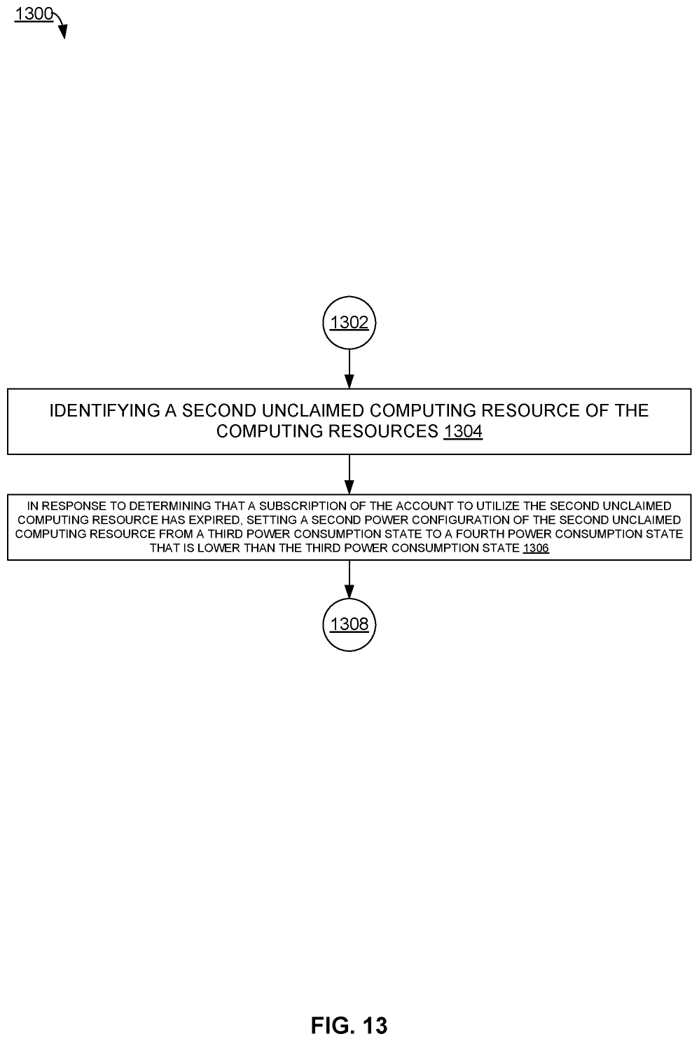

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 400 begins with 402, and moves to operation 404.

Operation 404 depicts contacting services.

After operation 404, process flow 400 moves to operation 406.

Operation 406 is reached from operation 404 or from operation 438.

Operation 406 depicts contacting an offer subscription service.

After operation 406, process flow 400 moves to operation 408.

Operation 408 is reached from operation 406, or from operation 418 where there is an hardware error or replacement. Operation 408 depicts contacting a device onboarding service.

After operation 408, process flow 400 moves to operation 410.

Operation 410 depicts contacting a device claim service.

After operation 410, process flow 400 moves to operation 412.

Operation 412 depicts determining whether there are unclaimed resources.

Where in operation 412 it is determined that there are unclaimed resources, then process flow 400 moves to operation 414. Instead, where in operation 412 it is determined that there are no unclaimed resources, then process flow 400 ends.

Operation 414 is reached from operation 412 where it is determined that there are unclaimed resources. Operation 414 depicts contacting an unclaimed resource handler service.

After operation 414, process flow 400 moves to operation 416.

Operation 416 depicts performing unclaimed resources analysis.

After operation 416, process flow 400 moves to operation 418.

Operation 418 depicts determining whether there is a hardware error or replacement.

Where in operation 418 it is determined that there is a hardware error or replacement, process flow 400 moves to operation 408. Instead, where in operation 418 it is determined that there is not a hardware error or replacement, process flow 400 moves to operation 420.

Operation 420 is reached from operation 418 where it is determined that there is not a hardware error or replacement. Operation 420 depicts determining whether there are consumer unclaimed resources or an ownership expiry. This can involve determining whether a device not claimed by the consumer or device ownership that issued during the onboarding service ticket is expired. Where any of the conditions are met, a device can be set to a low-powered state. If the conditions are not met, process flow 400 can terminate.

Where in operation 420 it is determined that there is consumer unclaimed resources or an ownership expiry, process flow 400 moves to operation 422 and operation 440. Instead, where in operation 420 it is determined that there is not consumer unclaimed resources or an ownership expiry, then process flow 400 ends.

Operation 422 is reached from operation 420 where it is determined that there is consumer unclaimed resources or an ownership expiry. Operation 422 depicts accessing a consumer trust analyzer.

After operation 422, process flow 400 moves to operation 424.

Operation 424 depicts determining a device trust factor. This can be determined based on considerations such as hardware unit quality, operations, and product evaluation.

After operation 424, process flow 400 moves to operation 426.

Operation 426 depicts determining consumer transaction history.

After operation 426, process flow 400 moves to operation 428.

Operation 428 depicts determining a trust confidence factor.

After operation 428, process flow 400 moves to operation 430.

Operation 430 depicts determining whether the trust confidence factor is high.

Where in operation 430 it is determined that the trust confidence factor is high, process flow 400 moves to operation 438. Instead, where in operation 430 it is determined that the trust confidence factor is not high, process flow 400 moves to operation 432.

Operation 432 is reached from operation 430 where it is determined that the trust confidence factor is not high. Operation 432 depicts determining whether the trust confidence factor is medium.

Where in operation 432 it is determined that the trust confidence factor is medium, process flow 400 moves to operation 438. Instead, where in operation 432 it is determined that the trust confidence factor is not medium, process flow 400 moves to operation 434.

Operation 434 is reached from operation 430 where it is determined that the trust confidence factor is not medium. Operation 434 depicts determining whether the trust confidence factor is low.

Where in operation 434 it is determined that the trust confidence factor is low, process flow 400 moves to operation 438. Instead, where in operation 434 it is determined that the trust confidence factor is not low, process flow 400 moves to operation 436.

Operation 436 is reached from operation 430 where it is determined that the trust confidence factor is not low. Operation 436 depicts determining that a trust confidence factor is not applicable.

After operation 436, process flow 400 moves to operation 416 with a determination that there are no incentives applicable to the current scenario.

Operation 438 is reached from operation 430 where it is determined that the trust confidence factor is high; from operation 432 where it is determined that the trust confidence factor is medium; and from operation 436 where it is determined that the trust confidence factor is low. Operation 438 depicts accessing an incentive modifier. In operation 438, an incentive offered to a consumer of a computing resource subscription to transition computers to a low power state can be made on the trust confidence factor determined in operations 430-434.

It can be appreciated that the example of a trust confidence factor being high, medium, or low is one example, and that other examples can be implemented. In some examples, the incentive in operation 438 can be modified based on factors such as per consumer license and a consumer usage fee.

After operation 438, process flow 400 moves to operation 406.

Operation 440 is reached from operation 420 where it is determined that there is consumer unclaimed resources or an ownership expiry. Operation 440 depicts accessing a remote computer device power configuration.

After operation 440, process flow 400 moves to operation 442.

Operation 442 depicts setting the remote computer to a low power state.

After operation 442, process flow 400 moves to 444, where process flow 400 ends.

### Example Architecture

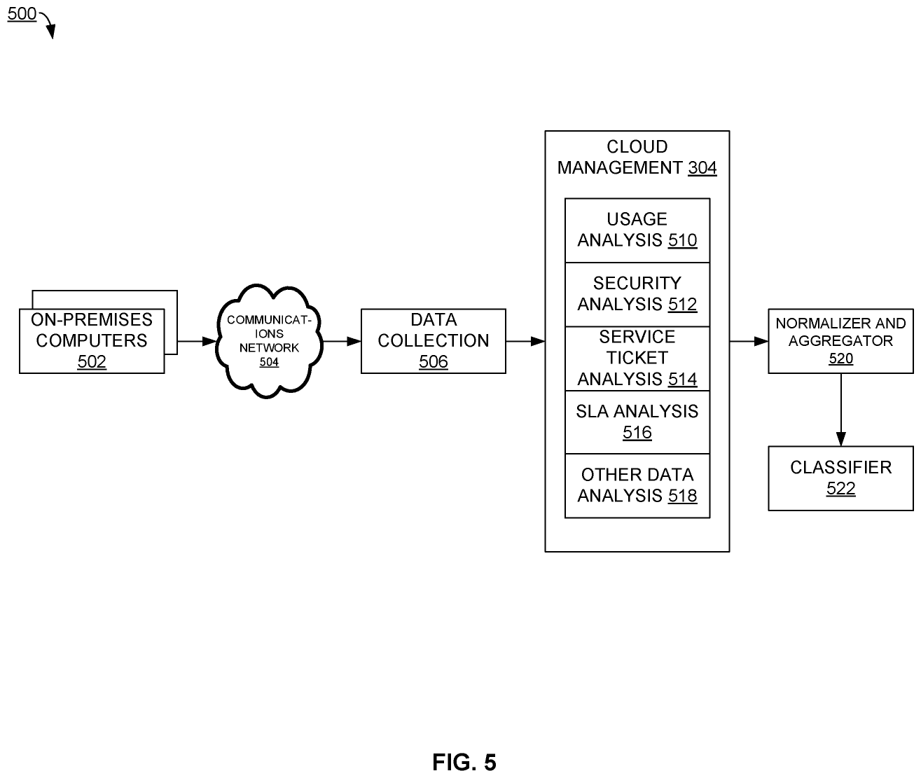

FIG. 5 illustrates another example system architecture 500 that can facilitate incentive based cloud resource provisioning, in accordance with an embodiment of this disclosure. In some examples, part(s) of system architecture 500 can be used to implement part(s) of system architecture 100 of FIG. 1 to facilitate incentive based cloud resource provisioning.

System architecture 500 comprises on-premises computers 502 (which can be similar to on-premises computers 106 of FIG. 1), communications network 504 (which can be similar to communications network 104), data collection 506, data analysis 508, usage analysis 510, security analysis 512, service ticket analysis 514, service level agreement (SLA) analysis 516, other data analysis 518, normalizer and aggregator 520, and classifier 522.

Data collection 506 collects and stores telemetry data (e.g., metrics) from on-premises computers 502. The collected data can generally be stored in a central data repository.

Data analysis 508 can comprise metric-specific analysis blocks that analyze metrics of interest and generate an analysis score. It can be appreciated that the examples of metric-specific analysis blocks herein are examples, and that other types of metric-specific analysis blocks can be implemented.

Usage analysis 510 comprises a metric-specific analysis block that is configured to analyze usage telemetry data to identify a usage trend for a device.

Security analysis 512 comprises a metric-specific analysis block that is configured to analyze audit logs and other security logs to detect security breaches and violations for a device.

Service ticket analysis 514 comprises a metric-specific analysis block that is configured to analyze data from a services/site reliability engineering (SRE) database to identify a loan on a SRE team to service a device. Items like a total number of tickets opened, a number of service calls created, etc., can be used to determine the load.

SLA analysis 516 comprises a metric-specific analysis block that is configured to analyze whether SLA metrics are being met for a consumer associated with a device.

Other data analysis 518 comprises a metric-specific analysis block for other types of data to add information about an overall trust factor.

Normalizer and aggregator 520 comprises a component that is configured to receive an analysis score from each metric-specific analysis block of data analysis 508, and aggregate and normalize these scores before sending them to classifier 522. An example of an approach used by normalizer and aggregator 520 can be a normalized weighted-sum aggregation.

Classifier 522 comprises a component that is configured to classify input received from normalizer and aggregator 520 into a finite set of classes (or in some examples, a numeric value that represents a trust score). In an example, classifier 522 can be implemented as a supervised multi-class classifier that is trained with organic and/or synthetic data.

### Example Process Flows

FIG. 6 illustrates another example process flow 600 for incentive based cloud resource provisioning, in accordance with an embodiment of this disclosure. In some examples, one or more embodiments of process flow 600 can be implemented by incentive based cloud resource provisioning component 108 of FIG. 1, or computing environment 1400 of FIG. 14.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 700 of FIG. 7, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 600 begins with 602, and moves to operation 604.

Operation 604 depicts identifying an unclaimed computing resource of computing resources installed for a user account on premises at a physical location associated with the user account, wherein the system is configured to remotely manage the computing resources. The computing resources can be similar to on-premises computers 106 of FIG. 1. In some examples, operation 604 can be implemented in a similar manner as operations 412-416 of FIG. 4.

After operation 604, process flow 600 moves to operation 606.

Operation 606 depicts analyzing a state of the computing resources to determine a trust factor that is associated with the user account. A customer can purchase a subscription for more resources than it needs, so does not utilize all of the subscribed resources. This can put systems at risk by being unclaimed due to security risks, while also increasing electrical power utilization to keep these unclaimed systems powered on.

This trust factor can be similar to the trust confidence factor of operation 424 of FIG. 4.

After operation 606, process flow 600 moves to operation 608.

Operation 608 depicts setting a power configuration of the unclaimed computing resource to a lower power consumption state relative to a current power consumption state based on the trust factor and a resource consumption history of the computing resources that is associated with the user account. In some examples, this can be implemented in a similar manner as operation 442 of FIG. 4.

After operation 608, process flow 600 moves to 610, where process flow 600 ends.

FIG. 7 illustrates another example process flow 700 for incentive based cloud resource provisioning, in accordance with an embodiment of this disclosure. In some examples, one or more embodiments of process flow 700 can be implemented by incentive based cloud resource provisioning component 108 of FIG. 1, or computing environment 1400 of FIG. 14.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 600 of FIG. 6, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

In some examples, process flow 700 is implemented in conjunction with process flow 600 of FIG. 6, and a monetary cost is applied to the user account for the computing resources.

Process flow 700 begins with 702, and moves to operation 704.

Operation 704 depicts setting the power configuration of the unclaimed computing resource to the lower power consumption state. In some examples, operation 704 can be implemented in a similar manner as operation 608 of FIG. 6.

In some examples, operation 704 can comprise communicating, via the user account, offer data indicative of an offer to reduce the monetary cost applied to the user account based on setting the power configuration of the unclaimed computing resource to the lower power consumption state, and receiving acceptance data associated with the user account indicative of accepting the offer. That is, in some examples, operation 704 can be implemented in a similar manner as operations 438 and 406 of FIG. 4.

After operation 704, process flow 700 moves to operation 706.

Operation 706 depicts reducing the monetary cost applied to the user account. In some examples, operation 706 can be implemented in a similar manner as operation 438 of FIG. 4.

In some examples, operation 706 can comprise determining an amount by which to reduce the monetary cost applied to the user account based on the trust factor. That is, a trust confidence factor of high (operation 430 of FIG. 4), medium (operation 432), or low (operation 430) can be used.

In some examples, operation 706 comprises determining an amount by which to reduce the monetary cost applied to the user account based on a power savings associated with the setting of the power configuration of the unclaimed computing resource to the lower power consumption state. That is, in some examples, operation 706 can be implemented in a similar manner as operation 438 of FIG. 4.

In some examples, operations 704-706 combine to comprise reducing the monetary cost applied to the user account based on setting the power configuration of the unclaimed computing resource to the lower power consumption state.

After operation 706, process flow 700 moves to 708, where process flow 700 ends.

FIG. 8 illustrates another example process flow 800 for incentive based cloud resource provisioning, in accordance with an embodiment of this disclosure. In some examples, one or more embodiments of process flow 800 can be implemented by incentive based cloud resource provisioning component 108 of FIG. 1, or computing environment 1400 of FIG. 14.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 600 of FIG. 6, process flow 700 of FIG. 7, process flow 900 of FIG. 9, process flow 1000 of FIG. 10, process flow 1100 of FIG. 11, process flow 1200 of FIG. 12, and/or process flow 1300 of FIG. 13.

In some examples, process flow 800 is implemented in conjunction with process flow 600 of FIG. 6, and a monetary cost is applied to the user account for the computing resources.

Process flow 800 begins with 802, and moves to operation 804.

Operation 804 depicts setting the power configuration of the unclaimed computing resource to the lower power consumption state. In some examples, operation 804 can be implemented in a similar manner as operation 442 of FIG. 4.

After operation 804, process flow 800 moves to operation 806.

Operation 806 depicts determining to refrain from reducing the monetary cost to the user account. In some examples, operation 806 can be implemented in a similar manner as operation 436 of FIG. 4, where the trust confidence factor is determined to be not applicable, so there are no incentives applicable to be used by an unclaimed resources analyzer in operation 416.

In some examples, operations 804-806 combine to comprise determining to refrain from reducing the monetary cost to the user account based on setting the power configuration of the unclaimed computing resource to the lower power consumption state.

After operation 806, process flow 800 moves to 808, where process flow 800 ends.

FIG. 9 illustrates another example process flow 900 for incentive based cloud resource provisioning, in accordance with an embodiment of this disclosure. In some examples, one or more embodiments of process flow 900 can be implemented by incentive based cloud resource provisioning component 108 of FIG. 1, or computing environment 1400 of FIG. 14.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 600 of FIG. 6, process flow 700 of FIG. 7, process flow 800 of FIG. 8, process flow 1000 of FIG. 10, process flow 1100 of FIG. 11, process flow 1200 of FIG. 12, and/or process flow 1300 of FIG. 13.

In some examples, process flow 900 is implemented in conjunction with process flow 600 of FIG. 6, and the unclaimed computing resource is a first unclaimed computing resource.

Process flow 900 begins with 902, and moves to operation 904.

Operation 904 depicts identifying a second unclaimed computing resource of the computing resources. In some examples, operation 904 can be implemented in a similar manner as operation 414 of FIG. 4.

After operation 904, process flow 900 moves to operation 906.

Operation 906 depicts, in response to determining that there is a hardware error associated with the second unclaimed computing resource, initiating an onboarding procedure for the second unclaimed computing resource, wherein the onboarding procedure comprises verifying the second unclaimed computing resource. In some examples, operation 906 can be implemented in a similar manner as operation 418, where it is determined in operation 418 that there is a hardware error.

After operation 906, process flow 908 moves to 908, where process flow 900 ends.

FIG. 10 illustrates another example process flow 1000 for incentive based cloud resource provisioning, in accordance with an embodiment of this disclosure. In some examples, one or more embodiments of process flow 1000 can be implemented by incentive based cloud resource provisioning component 108 of FIG. 1, or computing environment 1400 of FIG. 14.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, process flow 1100 of FIG. 11, process flow 1200 of FIG. 12, and/or process flow 1300 of FIG. 13.

In some examples, process flow 1000 is implemented in conjunction with process flow 600 of FIG. 6, and the unclaimed computing resource is a first unclaimed computing resource.

Process flow 1000 begins with 1002, and moves to operation 1004.

Operation 1004 depicts identifying a second unclaimed computing resource of the computing resources. In some examples, operation 1004 can be implemented in a similar manner as operation 904 of FIG. 9.

After operation 1004, process flow 1000 moves to operation 1006.

Operation 1006 depicts, in response to determining that there is a hardware replacement associated with the second unclaimed computing resource, initiating an onboarding procedure for the second unclaimed computing resource, wherein the onboarding procedure comprises verifying the second unclaimed computing resource. In some examples, operation 1006 can be implemented in a similar manner as operation 418, where it is determined in operation 418 that there is a hardware replacement.

After operation 1006, process flow 1000 moves to 1008, where process flow 1000 ends.

FIG. 11 illustrates another example process flow 1100 for incentive based cloud resource provisioning, in accordance with an embodiment of this disclosure. In some examples, one or more embodiments of process flow 1100 can be implemented by incentive based cloud resource provisioning component 118 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, process flow 1000 of FIG. 10, process flow 1200 of FIG. 12, and/or process flow 1300 of FIG. 13.

Process flow 1100 begins with 1102, and moves to operation 1104.

Operation 1104 depicts identifying an unclaimed computing resource of computing resources installed on premises at a physical location associated with a user account. In some examples, operation 1104 can be implemented in a similar manner as operation 604 of FIG. 6.

After operation 1104, process flow 1100 moves to operation 1106.

Operation 1106 depicts analyzing a state of the computing resources to determine a trust value that is associated with the user account. In some examples, operation 1106 can be implemented in a similar manner as operation 606 of FIG. 6.

In some examples, the analyzing of the state of the computing resources to determine the trust value is based on usage metrics data of the user account for the computing resources. That is, usage analysis 510 of FIG. 5 can be performed.

In some examples, the analyzing of the state of the computing resources to determine the trust value is based on security analysis data of the user account for the computing resources. That is, security analysis 512 of FIG. 5 can be performed.

In some examples, the analyzing of the state of the computing resources to determine the trust value is based on log analysis data of the user account for the computing resources. That is, usage analysis 510 or service ticket analysis 514 of FIG. 5 can be performed.

In some examples, the analyzing of the state of the computing resources to determine the trust value is based service-level agreement data of the user account for the computing resources. That is, SLA analysis 516 of FIG. 5 can be performed.

In some examples, the analyzing of the state of the computing resources to determine the trust value is based on normalizing and aggregating a first metric associated with the user account for the computing resources and a second metric associated with the user account for the computing resources. That is, operations similar to those that normalizer and aggregator 520 of FIG. 5 is configured to perform can be performed.

In some examples, the analyzing of the state of the computing resources to determine the trust value comprises classifying the state of the computing resources as one classification type from a finite, defined group of classification types. That is, operations similar to those that classifier 522 of FIG. 5 is configured to perform can be performed. After operation 1106, process flow 1100 moves to operation 1108.

Operation 1108 depicts setting a power configuration of the unclaimed computing resource to a reduced power consumption state relative to a current power consumption state based on the trust value and a resource consumption history of the computing resources that is associated with the user account. In some examples, operation 1108 can be implemented in a similar manner as operation 608 of FIG. 6.

After operation 1108, process flow 1100 moves to 1110, where process flow 1100 ends.

FIG. 12 illustrates another example process flow 1200 for incentive based cloud resource provisioning, in accordance with an embodiment of this disclosure. In some examples, one or more embodiments of process flow 1200 can be implemented by incentive based cloud resource provisioning component 128 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1300 of FIG. 13.

Process flow 1200 begins with 1202, and moves to operation 1204.

Operation 1204 depicts identifying an unclaimed computing resource of computing resources installed on premises at a physical location associated with an account. In some examples, operation 1204 can be implemented in a similar manner as operation 604 of FIG. 6.

After operation 1204, process flow 1200 moves to operation 1206.

Operation 1206 depicts analyzing a state of the computing resources to determine a trust value that is associated with the account. In some examples, operation 1206 can be implemented in a similar manner as operation 606 of FIG. 6.

In some examples, the analyzing of the state of the computing resources to determine the trust value is based on service tickets for the computing resources that are associated with the account. That is, data from a services/SRE database can be analyzed to identify a load on a SRE team to service a particular computer device. Items like a total number of tickets opened, a number service calls created, etc., can be used to determine the load.

In some examples, the analyzing of the state of the computing resources to determine the trust value is performed by a trained classifier, wherein the trust value comprises a classification type, wherein the trained classifier is configured to produce an output of the classification type from a finite group of classification types from an input of the state of the computing resources, and wherein the trained classifier is trained with training data before the analyzing of the state of the computing resources is performed. That is, operations similar to those that classifier 522 of FIG. 5 is configured to perform can be performed.

In some examples, the analyzing of the state of the computing resources to determine the trust value is based on a hardware unit quality of the computing resources, operations performed on the computing resources, or a product evaluation of the computing resources. That is, a device trust factor similar to that of operation 424 of FIG. 4 can be used.

After operation 1206, process flow 1200 moves to operation 1208.

Operation 1208 depicts setting a power configuration of the unclaimed computing resource from a first power consumption state to a second power consumption state lower than the first power consumption state based on the trust value and a resource consumption history of the computing resources that is associated with the account. In some examples, operation 1208 can be implemented in a similar manner as operation 608 of FIG. 6.

After operation 1208, process flow 1200 moves to 1210, where process flow 1200 ends.

FIG. 13 illustrates another example process flow 1300 for incentive based cloud resource provisioning, in accordance with an embodiment of this disclosure. In some examples, one or more embodiments of process flow 1300 can be implemented by incentive based cloud resource provisioning component 138 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

In some examples, process flow 1300 is implemented in conjunction with process flow 1200 of FIG. 12, the unclaimed computing resource of process flow 1200 is a first unclaimed computing resource, and the power configuration is a first power configuration.

Process flow 1300 begins with 1302, and moves to operation 1304.

Operation 1304 depicts identifying a second unclaimed computing resource of the computing resources. In some examples, operation 1304 can be implemented in a similar manner as operation 904 of FIG. 9.

After operation 1304, process flow 1300 moves to operation 1306.

Operation 1306 depicts, in response to determining that a subscription of the account to utilize the second unclaimed computing resource has expired, setting a second power configuration of the second unclaimed computing resource from a third power consumption state to a fourth power consumption state that is lower than the third power consumption state. In some examples, operation 1306 can be implemented in a similar manner as operation 420 of FIG. 4.

After operation 1306, process flow 1300 moves to 1308, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of hybrid cloud management system 102, and/or on-premises computers 106 of FIG. 1, and/or cloud management 304 and/or resources 310 of FIG. 3.

In some examples, computing environment 1400 can implement one or more embodiments of the process flows of FIGS. 4 and/or 6-13 to facilitate incentive based cloud resource provisioning.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that, in response to execution by the processor, cause the system to perform operations, comprising:
identifying an unclaimed computing resource of computing resources installed for a user account on premises at a physical location associated with the user account, wherein the system is configured to remotely manage the computing resources;
analyzing a state of the computing resources to determine a trust factor that is associated with the user account; and
setting a power configuration of the unclaimed computing resource to a lower power consumption state relative to a current power consumption state based on the trust factor and a resource consumption history of the computing resources that is associated with the user account.

2. The system of claim 1, where a monetary cost is applied to the user account for the computing resources, and wherein the operations further comprise:
reducing the monetary cost applied to the user account based on setting the power configuration of the unclaimed computing resource to the lower power consumption state.

3. The system of claim 2, wherein the operations further comprise:
communicating, via the user account, offer data indicative of an offer to reduce the monetary cost applied to the user account based on setting the power configuration of the unclaimed computing resource to the lower power consumption state; and
receiving acceptance data associated with the user account indicative of accepting the offer.

4. The system of claim 2, wherein the operations further comprise:
determining an amount by which to reduce the monetary cost applied to the user account based on the trust factor.

5. The system of claim 2, wherein the operations further comprise:
determining an amount by which to reduce the monetary cost applied to the user account based on a power savings associated with the setting of the power configuration of the unclaimed computing resource to the lower power consumption state.

6. The system of claim 1, where a monetary cost is applied to the user account for the computing resources, and wherein the operations further comprise:
determining to refrain from reducing the monetary cost to the user account based on setting the power configuration of the unclaimed computing resource to the lower power consumption state.

7. The system of claim 1, wherein the unclaimed computing resource is a first unclaimed computing resource, and wherein the operations further comprise:
identifying a second unclaimed computing resource of the computing resources; and
in response to determining that there is a hardware error associated with the second unclaimed computing resource, initiating an onboarding procedure for the second unclaimed computing resource, wherein the onboarding procedure comprises verifying the second unclaimed computing resource.

8. The system of claim 1, wherein the unclaimed computing resource is a first unclaimed computing resource, and wherein the operations further comprise:
identifying a second unclaimed computing resource of the computing resources; and
in response to determining that there is a hardware replacement associated with the second unclaimed computing resource, initiating an onboarding procedure for the second unclaimed computing resource, wherein the onboarding procedure comprises verifying the second unclaimed computing resource.

9. A method, comprising:
identifying, by a system comprising a processor, an unclaimed computing resource of computing resources installed on premises at a physical location associated with a user account;
analyzing, by the system, a state of the computing resources to determine a trust value that is associated with the user account; and
setting, by the system, a power configuration of the unclaimed computing resource to a reduced power consumption state relative to a current power consumption state based on the trust value and a resource consumption history of the computing resources that is associated with the user account.

10. The method of claim 9, wherein the analyzing of the state of the computing resources to determine the trust value is based on usage metrics data of the user account for the computing resources.

11. The method of claim 9, wherein the analyzing of the state of the computing resources to determine the trust value is based on security analysis data of the user account for the computing resources.

12. The method of claim 9, wherein the analyzing of the state of the computing resources to determine the trust value is based on log analysis data of the user account for the computing resources.

13. The method of claim 9, wherein the analyzing of the state of the computing resources to determine the trust value is based service-level agreement data of the user account for the computing resources.

14. The method of claim 9, wherein the analyzing of the state of the computing resources to determine the trust value is based on normalizing and aggregating a first metric associated with the user account for the computing resources and a second metric associated with the user account for the computing resources.

15. The method of claim 9, wherein the analyzing of the state of the computing resources to determine the trust value comprises:
classifying the state of the computing resources as one classification type from a finite, defined group of classification types.

16. A non-transitory computer-readable medium comprising instructions that, in response to execution, cause a system comprising a processor to perform operations, comprising:
identifying an unclaimed computing resource of computing resources installed on premises at a physical location associated with an account;
analyzing a state of the computing resources to determine a trust value that is associated with the account; and
setting a power configuration of the unclaimed computing resource from a first power consumption state to a second power consumption state lower than the first power consumption state based on the trust value and a resource consumption history of the computing resources that is associated with the account.

17. The non-transitory computer-readable medium of claim 16, wherein the unclaimed computing resource is a first unclaimed computing resource, wherein the power configuration is a first power configuration, and wherein the operations further comprise:
identifying a second unclaimed computing resource of the computing resources; and
in response to determining that a subscription of the account to utilize the second unclaimed computing resource has expired, setting a second power configuration of the second unclaimed computing resource from a third power consumption state to a fourth power consumption state that is lower than the third power consumption state.

18. The non-transitory computer-readable medium of claim 16, wherein the analyzing of the state of the computing resources to determine the trust value is based on service tickets for the computing resources that are associated with the account.

19. The non-transitory computer-readable medium of claim 16, wherein the analyzing of the state of the computing resources to determine the trust value is performed by a trained classifier, wherein the trust value comprises a classification type, wherein the trained classifier is configured to produce an output of the classification type from a finite group of classification types from an input of the state of the computing resources, and wherein the trained classifier is trained with training data before the analyzing of the state of the computing resources is performed.

20. The non-transitory computer-readable medium of claim 16, wherein the analyzing of the state of the computing resources to determine the trust value is based on a hardware unit quality of the computing resources, operations performed on the computing resources, or a product evaluation of the computing resources.
